(19) United States
(12) Patent Application Publication
(10) Pub. No.: US 2004/0187750 A1
(43) Pub. Date: Sep. 30, 2004

(54) Ring sealing arrangement for an indirectly heated rotary kiln

(76) Inventors: Peter H. Raichle, Dorsten (DE); Harry F. Werner, Essen (DE)

Correspondence Address: Mark E. Bandy, Esq., Fay, Sharpe, Fagan, Minnich & McKee, LLP, Seventh Floor, 1100 Superior Avenue, Cleveland, OH, 44114-2579, US

(21) Appl. No.: 10/773,977

(22) Filed: Feb. 6, 2004

(30) Foreign Application Priority Data
Feb. 8, 2003 (DE) 203 02 000.6

(51) Int. Cl. A47J 36/00; F23G 5/12

(52) U.S. Cl. 110/246; 110/229

(57) ABSTRACT

A ring sealing arrangement for an indirectly heated rotary tubular kiln between a heating tunnel and a rotating tube (20) with several overlapping segments (10), forming a sealing ring, which are pressed by application pressure elements (30) radially against the rotating tube (20). The segments (10) are essentially made of a heat-resistant, light construction sealing material. The sealing ring consists of several flat band-like sections (32), which are connected with one another, especially by springs (34), and form a tightening ring.

The invention refers to a ring sealing arrangement for an indirectly heated rotary kiln according to the preamble of Claim 1.

### BACKGROUND OF THE INVENTION

Indirectly heated rotary kilns comprise a rotating tube, which is mostly surrounded by a bowl-shaped heating tunnel. Usually, the rotating tube is not completely surrounded by the tunnel, but rather projects from the tunnel on both front sides. Within the heating tunnel, heated gas is conducted through the heating tunnel, in order to manufacture the energy for the chemical and/or thermal processes taking place in the rotating tube. To this end, the heating tunnel has one or more inlets and outlets for heating gas.

The rotating tube must be sealed off with respect to the front sides of the heating tunnel, so that the heating medium cannot frontally flow out of the heating tunnel and/or so that the surrounding air cannot flow into the heating tunnel. Such a flowing out of the heating medium reduces, on the one hand, the efficiency of the heating process within the heating tunnel; on the other hand, areas lying outside the tunnel are unnecessarily and undesirably subjected in part to the considerable heat of the heating medium. An efficient sealing is particularly important if flue gas or something similar is used as the heating medium. An undesired escape of the heating medium would then mean an environmental pollution also. In the same way, an undesired flowing in of surrounding air signifies an efficiency loss.

Usually, such rotating tube-circumferential sealings comprise segments of cast iron or a carbide-carbon fiber mixture. As a rule, they are pressed on the rotating drum via a cable feed loaded with weights. Cast iron segments have thereby the disadvantage that the abrasion is particularly high and a qualified sealing does not exist on the joints of the segments. Segments made of a carbide-carbon fiber mixture tend to fractures because of their brittleness, so that they frequently must be replaced, which leads to idle times.

With circumferential sealings for heating tunnels, according to the state of the art, the selection of the application pressure is particularly a problem. If it is too high, then this leads to an intensified abrasion on the segments and/or the rotating tube; if it is too low, then this leads to the entry of secondary air from the surroundings or the exit of heating medium from the rotary tubular kiln. Another disadvantage of such sealings is that especially because of the high load of the sealing—the application pressures, as a rule, are 600 kN—the average service life of these sealings is frequently less than a year, mostly even no longer than six months.

In the selection of the material for a heating tunnel circumferential sealing, one should consider that the heating medium of the rotary tubular kiln consists mostly of a gas which is heated to several hundred degrees, often above 1000° C., and on top of that, is oxidizing. It must be guaranteed that even under these conditions, the material has a sufficiently large stability.

From German Patent No. 30 47 404A1, a ring sealing for a rotary kiln is known, which is provided as a stationary ring, which is made from a number of graphite parts, which, in part, are arranged in the form of a ring, overlapping and abutting on one another and are held with their inner side in place against a cylindrical rotating tube surface, which is coaxial with respect to the rotary kiln and rotates with it. The pressing is done by a cable loop under tension at its ends, which surrounds the graphite units. The rotary kiln described in this publication, however, is not an indirectly heated rotary kiln, so that the ring sealing is exposed to far lower temperatures and temperature differences. Furthermore, here the application pressure must also lie in the aforementioned order of magnitude because of the material (graphite).

### THE INVENTION

The problem, therefore, is to create a ring sealing with increased stability for an indirectly heated rotary tubular kiln. A simplified sealing replacement is also desired, for example, in order to be able to reduce idle times.

To solve this problem, a sealing with the features of claim I is proposed. Accordingly, the invention is based on the basic idea that with a ring sealing for an indirectly heated rotary tubular kiln between a heating tunnel and a rotating tube, in which several, overlapping segments are present, pressed against the rotating drum radially by contact pressure elements, the segments are essentially made of a heat-resistant light construction sealing material. Particularly preferred are felts, in particular, made of carbon fibers. What is thereby understood by a felt material, in the sense of the invention, is that material fibers of the same or different, not excessively short length form a material packet, in more or less great irregularity, which, as a rule, has a certain porosity, but nevertheless, is sufficiently compact. Inner cavities and channels are preferably avoided. Such a material is preferably dimensionally stable and is made—with particular preference—of graphite fibers and a carbon binder. The characteristics of the starting fibers and their length and the type of binder and the degree of compression and a possible thermal treatment can be specified within certain limits. It is also particularly preferred if this material is coked and graphitized. In extreme cases, it can be used up to temperatures of 3000° C. and is known in the form of self-supporting plates, cylinders, and other construction parts, among others, as graphite adhesive felt, under the trademark designation of SIGRATHERM®. A typical material density is, as a rule, below 1 g/cm³. Particularly preferred are bulk densities of # 0.16 g/cm³. In any case, in the sense of the invention, “light construction sealing material” is understood to be such a sealing material, whose density is # 1.5 g/cm³.

In this way, surprisingly, the necessary application forces are considerably reduced. This, in turn, has the effect of lengthening the service life.

The application pressure elements thereby preferably have a closed ring, which encompasses the segments radially and elastically on the side turned away from the rotating tube. In an embodiment preferred in this respect, the application pressure elements comprise several band sections, which form a tightening ring and are connected with one another, especially by springs or also other elastic, tightening means. A band-shaped tightening ring distributes the application pressures required, which are, in any case, only small, to an advantageously large surface.

In one sealing, in accordance with the invention, the required application pressure is substantially smaller in comparison to the state of the art. With some embodiments, it is now only 30 to 50 kN. With the presence of a tightening ring, described above, the application pressure can also be calculated precisely, since unlike the case with the cable tension loops with weights or the like on their ends, the segments are pressed in a uniform radial manner on the rotating tube, with little static friction.

The light construction sealing material no longer exerts abrasion forces on the rotating tube. In a preferred embodiment, the segments of the sealing are made of material which has a polishing effect on the rotating tube. In this way, the rotating tube is less impaired, on the one hand, than with sealings according to the state of the art. On the other hand, the surface roughness of the sealing surface of the rotating tube is reduced, which improves the sealing and thus reinforces tightness even more. As a result of the lesser surface roughness of the rotating pipe, the wear of the sealing is also less, which increases or improves, once more, the service life and sealing characteristics of the sealing. A carbon fiber felt is also suitable, as a material, for this purpose.

The aforementioned and the claimed components, to be used in accordance with the invention and described in the embodiment examples, are not subject to any special conditions in their size and shaping, material selection, and technical design, so that selection criteria known in the application area can be used without limitation.

Other details, features, and advantages of the object of the invention can be deduced from the dependent claims and from the following description of the pertinent drawings, in which—by way of example—several embodiment examples of the sealing in accordance with the invention are described. In the drawings, the figures show the following:

### BRIEF DESCRIPTION OF THE DRAWINGS

FIG. 1, a sealing arrangement in (axial) side view—Section along line IV-IV according to FIG. 6—schematically and without cover;

FIG. 2, from the same sealing arrangement, a sealing segment, in accordance with the invention, in radial outside view (view A-A), according to FIG. 1, in overlapping of adjacent sealing segments, on both sides;

FIG. 3, the same sealing segment in a front-side view analogous to Figure 1;

FIG. 4, an alternative embodiment of a sealing segment, in accordance with the invention, in the same view as FIG. 3;

FIG. 5, a perspective blowup view of two sealing elements from FIG. 4—in sections; and

FIG. 6, a rotary tubular kiln with a sealing in accordance with the invention, in axial sectional view, schematic and in sections.

### PREFERRED EMBODIMENT

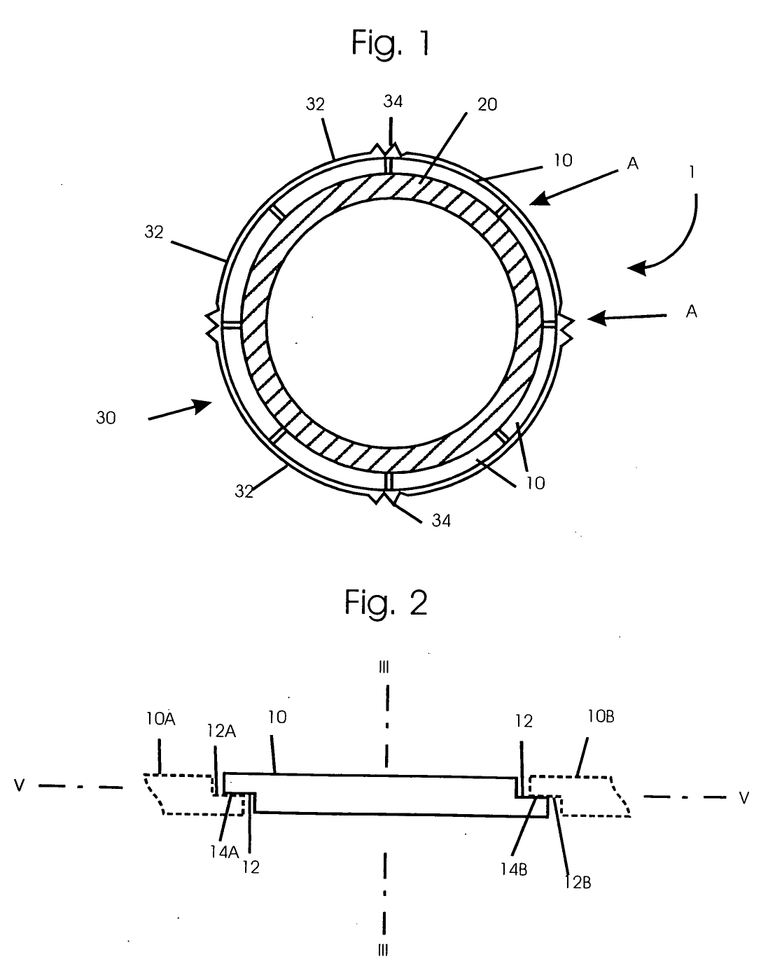

As can be deduced from FIG. 1, a ring sealing arrangement 1, in accordance with the invention, comprises a ring of sealing segments 10, which surrounds the rotating tube 20 of an indirectly heatable rotary tubular kiln radially. The sealing segments 10 are made of a light construction sealing material, which preferably has a heat resistance of more, especially clearly more than 280° C., for example >1000° C. Preferably, the sealing segments 10 are made of a material, which is also heat-resistant in an oxidizing atmosphere. Thus, there are great selection possibilities in the choice of the heating medium for the rotary tubular kiln. A suitable material is high-temperature carbon fiber felt, as it was described in the beginning. With a practical embodiment example, a graphite hard felt was used, which was additionally coated with a graphite film # 0.5 mm (coating, 10 C) on the side surface facing the heating tunnel. A coating of the sealing surfaces 14 C and/or 14 D with lubricating promoters, such as graphite paste, simultaneously works also to increase tightness.

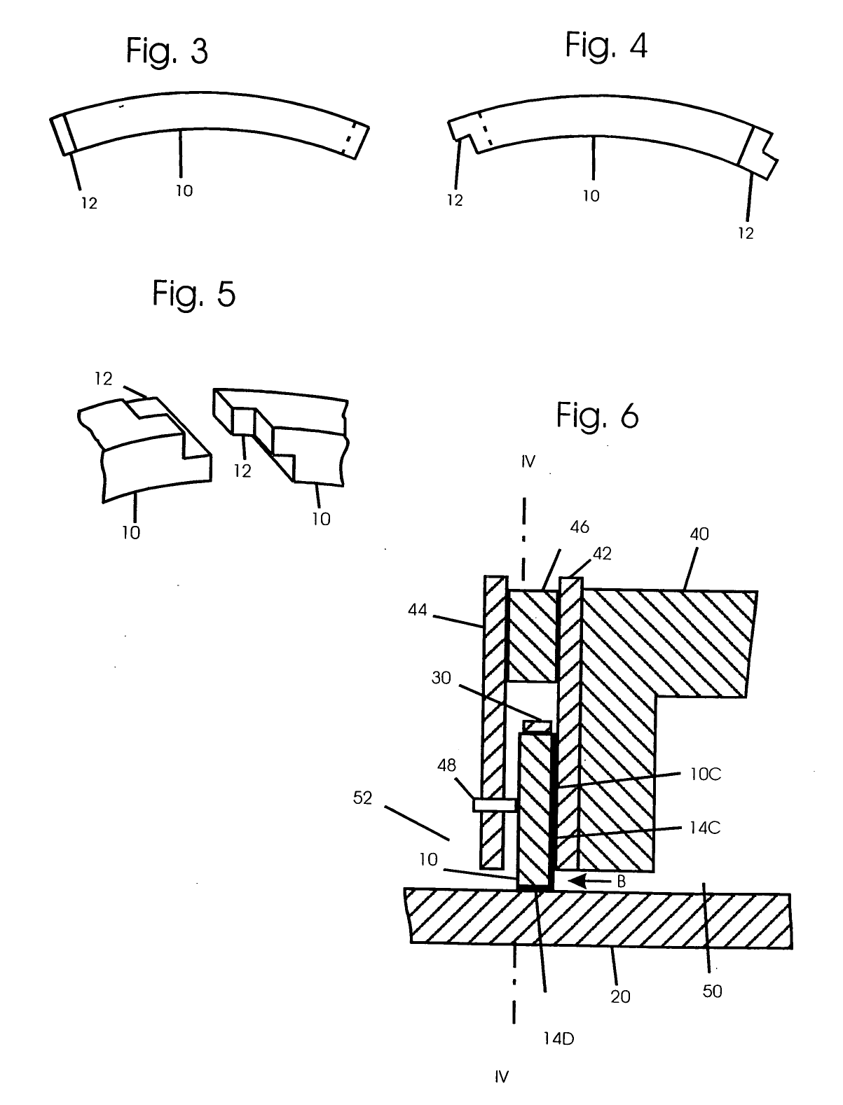

As can be deduced from FIG. 2, a sealing segment 10 has two overlapping projections 12. When using the sealing, the overlapping projections 12, 12A or 12, 12B overlap adjacent sealing segments 10, 10A or 10, 10B extensively and form contact surfaces 14A and 14B. A sealing segment thereby overlaps the adjacent segments, now on the tunnel side and then away from the tunnel. As can be seen in FIG. 3, these overlapping projections can be rectangle-like circular segment sections. However, other embodiments are also conceivable, such as in FIG. 4, where a sealing element with a graduated overlapping projection 12 is shown. A sealing element can also comprise, however, overlapping projections with a gradual graduation. For a better illustration of the overlapping, FIG. 5 shows a perspective representation of two sealing elements in sections—here the elements from FIG. 4.

In a running operation, the sides of the sealing elements 10, facing the rotating tube, are rubbed somewhat by the rotating tube 20. Since the sealing elements 10—as will be described latter more precisely—are pressed radially against the rotating tube 20, the sealing segments 10, 10A and 10, 10B “move” somewhat toward one another with wear and the contact surface 14A and 14B is increased. In this way, the complete functional capacity of the sealing is retained.

FIG. 1 shows a ring consisting of 8 sealing segments the number of sealing segments, however, can vary, depending on the requirement and size of the rotary tubular kiln. The number of sealing segments, however, should be kept as low as possible. Mostly, the number of sealing segments is approximately between 6 and 12.

According to FIG. 1 and in this respect preferred, the sealing segments have an identical form, at least when the sealing is first put to use. This guarantees a uniform sealing of the rotating tube 20. However, embodiments of the sealing are also conceivable, in which at least not all sealing segments are identical, for example, in that larger and smaller segments alternate or the segments otherwise vary.

On their side turned away from the rotating tube, the sealing segments 10 are surrounded by one or more application pressure elements 30, which press the sealing segments 10 radially against the rotating tube 20. The application pressure elements 30 are preferably designed as a closed ring, which elastically encompasses the segments radially on their side turned away from the rotating tube. Preferably, the ring—as shown in FIG. 1—consists of several flat band-shaped sections 32, which are bound with one another, especially by springs 34, and thus form a tightening ring. This guarantees a uniform radial application pressure over the entire rotating tube circumference. Instead of springs, it is also possible to use other elastic tightening means.

Alternately, however, all application pressure elements can be used, which guarantee a radial application pressure of the sealing segments against the rotating tube. One possible alternative application pressure element would be, for example, a flat band, completely wrapping the sealing segment ring, with ends which overlap one another and which, in turn—for example, via cable pulls—is held under tension. In the same way, the sealing segments can also be pressed via these encompassing tension cables themselves radially against the sealing.

The application pressure elements can, on the one hand, lie on the sealing segments, as can be seen in FIG. 6. A suitable recess can be present also, however, in the sealing segments 10; the recess holds the application pressure element or elements. With a suitable width of the sealing segment, several recesses can also be present.

The sealing segments are usually covered with a cover and/or guide on their side turned away from the rotating tube. This cover and/or guide thereby preferably has slits or recesses, by means of which the rubbings of the sealing are automatically removed from the sealing—for example, in that they drop out. This prevents rubbings from establishing themselves between the overlapping projections and their mobility from impairing or even blocking the sealing segments. If large parts of the side of the sealing segments, turned away from the rotating tube, are covered by the application pressure elements, they preferably also contain guides and/or slits.

In sections and not true-to-scale, FIG. 6 shows a longitudinal section through an embodiment of an indirectly heatable rotary tubular kiln with an installed sealing. A first holder 42 is placed on a heating tunnel 40, on its front end side; this holder is separated from a second holder 44 by a spacer 46. The two holding rings thereby have a certain radial distance to the rotating tube 20. The spacer 46 is placed in such a way, at a distance from the rotating tube, that there is sufficient space for the sealing segments 10 and the application pressure element 30 between the rotating tube and the spacer 46. If the spacer, as shown in FIG. 6, is somewhat wider than the sealing segments 10, the sealing segments 10 are pressed against the heating tunnel-side holding rings 42 by means of one or more application pressure elements. This can be done, for example, via one or more adjustment screws 48 arranged in the holding ring 44. However, all other application pressure systems which make possible a sealing placement of the sealing on a front surface are also conceivable. Thus, for example, the width of the spacer 46 can be dimensioned exactly so that it corresponds to the width of the sealing segments. If the sealing segment material can be compressed, the width of the sealing in operation can also be determined by the width of the spacer 46, in that the sealing segments are pressed in between the holding rings. In addition, the holder 42 can be part of the heating tunnel 40. The sealing segments 10 must, in any case, lie on the heating tunnel 40, so that heating medium found in its interior, which flows toward the sealing segments 10 along the rotating tube axis in the direction of arrow B, cannot flow around them laterally and thus cannot be introduced into the environment 52.

Explanation of Symbols

1 Ring sealing arrangement

10 Sealing segment

10A Sealing segment

10B Sealing segment

10C Coating

12 Overlapping projection

12A Sealing segment

12B Overlapping projection

14A Contact surface

14B Contact surface

14C Sealing surfaces

14D Sealing surfaces

20 Rotating tube

30 Application pressure element

32 Flat band-like sections

34 Spring

36 Tension cable

40 Heating tunnel

42 First holder

44 Second holder

46 Spacer

48 Adjustment screw

50 Interior space

52 Environment

d Distance

1. Ring sealing arrangement for an indirectly heated rotary tubular kiln between a heating tunnel and a rotating tube (20) with several overlapping segments (10), forming a sealing ring, which are pressed by application pressure elements (30) radially against the rotating tube (20), characterized in that the segments (10) are essentially made of a heat-resistant, light construction sealing material.

2. Ring sealing arrangement according to claim 1, characterized in that the segment material has a temperature stability greater than 280° C.

3. Ring sealing arrangement according to claim 1 or 2, characterized by a temperature stability of the segment material greater than 280° in an oxidizing atmosphere.

4. Ring sealing arrangement according to one of claims 1-3, characterized in that the segments essentially are made of high temperature-resistant felt, preferably, carbon fibers.

5. Ring sealing arrangement according to one of claims 1-4, characterized in that the application pressure element (30) is designed as a closed ring, which elastically encompasses the segments radially on their side turned away from the rotating tube.

6. Ring sealing arrangement according to claim 5, characterized in that the ring consists of several flat band-like sections (32), which are connected with one another, especially by springs (34), and form a tightening ring.

7. Ring sealing arrangement according to one of claims 1-6, characterized in that the segments (10) are made of a material which exerts a polishing effect on the sealing surface of the rotating tube.

8. Ring sealing arrangement according to one of claims 1-7, characterized in that the application pressing force of the sealing is less than 300 kN.

9. Ring sealing arrangement according to one of claims 1-8, characterized in that a cover or guide of the sealing ring has slits and/or recesses in such a way that rubbings are automatically removed from the sealing.

10. A ring sealing arrangement for an indirectly heated rotary tubular kiln between a heating tunnel and a rotating tube (20) with several overlapping segments (10), forming a sealing ring, which are pressed by application pressure elements (30) radially against the rotating tube (20), characterized in that, the application pressure element (30) is designed as a closed ring, which elastically encompasses the segments radially on their side turned away from the rotating tube.

11. Ring sealing arrangement according to claim 10, characterized in that the ring consists of several flat band-like sections (32), which are connected with one another, especially by springs (34), and form a tightening ring.

12. Ring sealing arrangement according to claim 10, characterized in that the segments (10) are made of a material which exerts a polishing effect on the sealing surface of the rotating tube.

13. Ring sealing arrangement according to claim 10, characterized in that the application pressing force of the sealing is less than 300 kN.

14. Ring sealing arrangement for an indirectly heated rotary tubular kiln between a heating tunnel and a rotating tube (20) with several overlapping segments (10), forming a sealing ring, which are pressed by application pressure elements (30) radially against the rotating tube (20), characterized in that, a cover or guide of the sealing ring has slits and/or recesses in such a way that rubbings are automatically removed from the sealing.
